(19) United States
(12) Patent Application Publication
(10) Pub. No.: US 2004/0153339 A1
(43) Pub. Date: Aug. 5, 2004

(54) Method and system for handling medical information

(76) Inventor: David J Hetzel, Asheville, NC (US)

Correspondence Address: William H Holt, Law Offices of William of Holt, Unit 2 First Floor, 1423 Powhatan Street, Alexandria, VA, 22314, US

(21) Appl. No.: 10/479,456

(22) PCT Filed: Nov. 13, 2002
(86) PCT No.: PCT/US02/36432

(51) Int. Cl. G06F 17/60

(52) U.S. Cl. 705/2

(57) ABSTRACT

A method and system of storing and transferring a patient's medical information to and from the patient, the patient's doctor, pharmacies, pharmaceutical manufacturers and emergency medical personnel wherein such information is accumalated on and maintained on a central system computer.

### BACKGROUND OF THE INVENTION

The modern world is replete with electronic devices such as mainframe, desktop, laptop and handheld computers, Personal Digital Assistants (PDA), modems, and other devices for storing, downloading, transferring, beaming or otherwise transferring data between the various devices by using wireless, or hard wire, infra red (IR), satellite or radio frequency transmission means.

In the medical field, it is known for pharmacies to record and store information with respect to a patient's prescribed medicines, including the patient's name, address, medicine, dosage, number of remaining refills and similar data. There are, however, many more applications that are not presently provided. It is a purpose of the present invention to provide new and improved services in this field.

### SUMMARY OF THE INVENTION

The invention provides a system and methods which, in return for a patient's permission to use personal data and information about his/her medical history, condition, illnesses, prescribed medicines and related data, will make possible a comprehensive list of benefits and health management services that have not been heretofore available. Through the use of modern electronic apparatus, the assembled data will be used for the benefit of the patient, the doctor(s), the pharmacies and the pharmaceutical manufacturers.

Patient services will include timely reminders for taking medicine, including proper timing and proper dosage, and reminders for scheduling appointments, refilling prescriptions, following treatment regimens, and the like, all of which can be programmed at the time of filling prescriptions or receiving medical attention. The patient will also benefit in case of emergencies because essential data will be available to emergency personnel.

Participating doctors, pharmacies and pharmaceutical manufacturers will benefit through access to accumulated data with respect to treatment regimens, dosages, changes in patient's health or condition, and other information contained in a Central Company database which will assist in nurturing customer loyalty and compliance thereby increasing sales, distribution and stocking levels.

### DESCRIPTION OF THE PREFERRED SYSTEM AND METHODS

The invention relates to a process that provides a service linking a pharmacy to its individual customers and their respective medical providers, while at the same time the process provides a service linking multiple pharmacies to individual pharmaceutical manufacturers. The process and service involve a prompt, reliable, accurate information exchange via downloading data, which occurs at the time of a patient's original medical office visit, and/or original prescription filling, or later at a remote site.

In accordance with the invention, the process provides for storage of information in a Central Company database and allows pharmacy retailers and manufacturers to offer a service to each of its customers. This service may be supplied directly or indirectly through a separate pharma information company. This service downloads a patient's personal medication schedule into their portable electronic device or alternately, programs an auto-dialer on the patient's personal communication device. This portable electronic device (PED) may be a watch, personal data assistant (PDA), a combination PED/personal communication device or other PEDs. The personal communication device may be a desktop or laptop computer, a display pager, a display cell phone, a web access pager/cell phone or a combination device. The patient's specific device subsequently prompts them to take each of their medications on a timely basis. The transmitted information prevents confusion by displaying the correct name of the medication, dose and number of pills and the correct time it should be taken. It alerts the patient with an alarm or vibration. The process in turn deters a patient from taking the wrong medicine or numbers of pills and deters delayed or forgotten doses. The service improves the problems of persistence, compliance, consistency and switching of medications. The process greatly lessons the likelihood of programming errors found in other devices where the patient must program their own device. The process also provides these capabilities for persons that are not motivated or skilled enough to provide them for themselves. The service supplied by the invention may be subsidized in part by a small fee generated for each download or medication programmed into the device. This fee may be charged to the pharmacy manufacturers or other health or insurance companies and subsidized out of the profits from the increase in drug compliance or benefits from lower health care costs.

The process begins by a customer or patient accessing a data interfacing device at their doctor's office, or retail pharmacy near or on the pharmacy's check-out computer workstation or at a remote site away from the pharmacy. In the case of a PED, the device would link to the database by an Infrared (IR) port or high speed interface such as a Universal Service Bus (USB) or Firewire. The PED would then transfer its access code to the database by transfer code and the patient would enter their personal identification number (PIN). In the case of a personal communication device such as a pager or cell phone, the patient would access the system by scanning a unique bar code attached to their device or manually punch in their unique access code number, followed by their PIN. According to the invention, system software will automatically extract the required information from the pharmacy's software platform or database. The system may alternately access existing information already in the Central Company database. It then sorts and reformulates the data appropriately for the customer's PED or auto-dialer for their personal communication device. The system then downloads, transmits, sends or beams the information into the patient's PED, or other device, by way of a transfer protocol such as through an IR port or other high speed interface. In the case of a pager or cell phone device, the system activates the programmed auto-dialer to enact the timed information specific alerts to the patient's device. In the case of portable web based communication, the system programs an auto-E-mail to enact the timed information specific alerts to the patient's device. The data interface station would then indicate if a successful download was achieved or if successful auto-dialer/Email programming was executed.

A similar process would occur at the physician's office when a patient would go for an examination. After the doctor has completed the examination, the patients typically hand carry a document which includes their bill with its corresponding Current Procedural Terminology (CPT) code(s), a diagnosis with its corresponding International Classification of Diseases (ICD) code(s) and the time interval for their next doctor's visit.

At the check-out desk the patient, or an assistant, would access a data interfacing device. In the case of a PED, the device would link to the Central Company's database by an IR port or other high speed interface such as USB or Firewire. The PED would then transfer its access code to the database by transfer code and the patient would enter their personal identification number (PIN). In the case of a personal communication device such as a pager or cell phone, the patient would access the system by scanning a unique bar code attached to their device or manually punch in their unique access code number, followed by their PIN. The system would access the existing Central System database. The web based access screen on the data interfacing station would allow a clerk to enter the patient's diagnosis ICD code(s) for that visit and the time and date of the next appointment. During the initial one-time set up of the patient's device, i.e., a watch, or PDA, etc., in the doctor's office, a nurse, or other assistant, would input demographic information, allergies, etc., and list the ICD diagnosis codes of any significant past and ongoing present medical problems and CPT codes for any past surgeries.

Subsequently, the system will build on any future problem list. The system will automatically add the particular physician's identifier and medical specialty category. All this information is then transferred to the Central Company's database. It then reformulates the data appropriately for the customer's PED or auto-dialer for their personal communication device. The Central Company's system then downloads some of this information into the patient's PED, etc., by way of a transfer protocol through an IR port or other high speed interface. In the case of a pager or cell phone device, it activates the programmed auto-dialer to enact the timed information specific alerts to the patient's device.

In the case of portable web based communication, the system programs an auto-E-mail to enact the timed information specific alerts to their device. The data interface station would then indicate if a successful download was achieved or if successful auto-dialer/Email programming was executed. This process programs the PED or personal communication device to alert the patient one day and one hour before their next scheduled doctor's appointment. It also allows for a personal physician message or health tip to be sent as a reminder to all of his/her patients enrolled in the system over their device once a month or at some other interval. This message or health tip could be changed as frequently as desired and may be automatically downloaded by each patient at the time of their next visit. At the same time the process builds valuable clinical information, demographics and diagnosis codes to correlate with the prescribed medications in the Central Company database.

During the above pharmacy and physician office downloads, valuable data is entered into the Central Company's database. In accord with the invention, the process reformats the data, adds any new or supplemental data, and compares it to the customer's last medication schedule and problem list. Preferably, this information does not include a customer's name or address or any other personal information that could identify them. Data that is included in the above downloads, as well as the physician and pharmacy set-up, will be very valuable to the industry such as customer and physician demographics, regional and pharmacy information, insurance carrier, and comparisons of previous medication combinations and changes, as well as associated ICD diagnosis codes to link with the medications the patients are on. The process continues by allowing further analysis and display of all the compiled data from multiple individuals and downloads. The process allows queries and comparisons of market share for individual drugs related to the diagnosis codes, drug combinations, duration of use, whether a certain drug was discontinued, and if so, which drug(s) the patients were switched to, queries by diagnosis and complications related to their specific disease or medications. The process therefore links the pharmacies and physicians to pharmaceutical manufacturers by providing them with accurate data and feedback about the drugs they manufacture, and how the drugs are being prescribed and used in the marketplace.

The foregoing portion of the inventive process provides a valuable and reliable service to the pharmaceutical manufacturers for market research and product use analysis. Manufacturers are to be licensed in order to access the Central Company database, to submit queries, and to obtain reports and answers generated from the data assembled and provided by the present invention.

Physicians may also be offered a summary of their patients on the Central Company's system with each diagnosis and associated medications given. They may be able to query for provider masked summary profiles of combined practice patterns stratified by medical specialty type. In this way, the doctors may be able to see e.g. what the other Internal Medicine doctors in the area are prescribing for high cholesterol, etc.

Another important aspect of the invention is that during emergency situations, the Central Company database can provide immediate critical information, which may save a patient's life. Emergency Medical Service (EMS) personnel may access the Central Company database by, for example, holding the patient's PED into a portable data interfacing station and punching in their master EMS PIN. The Central Company database will then download a medical profile to the interface station of the EMS personnel. This profile may include, for example, the patient's age, sex, race, medical problem list, diagnosis summary, list of all medications and doses, allergies, previous surgeries, name and phone number of personal physician and last appointment date. This information could be accessed by a doctor, nurse or authorized ER personnel in any Emergency Room in any region of the country. An EMS worker, such as a paramedic, Emergency Medical Technician (EMI), fire department personnel or police, could access this information in the field during any trauma situation. Therefore the present invention utilizes known types of apparatus in a unique way to provide a unique system and to execute a unique process, and variations thereof, for providing a new service which is an improvement from the present art.

The inventive system and processes create an important service for patients (customers), physicians, and the pharmaceutical manufacturers. This inventive process generates income for the pharmacy and manufacturers by improving compliance. It improves the manufacturers value and the value of pharmacy retailers and physicians in the community and in the industry.

The above description of a preferred system and related apparatus, and the preferred method steps of the novel process, define improvements in the art which captures pharmaceutical data in a new way, that is prompt, broader in nature then conventional methods, creates a bridge between various retail pharmacy software platforms to a common database, combining patient, medical and medication data from a plurality of pharmacy chains, physician offices across geographical regions, through the use of a Central Company database to ultimately provide a more comprehensive, more accurate market evaluation, in a real-time format, for the benefit of the patient's, doctors, pharmacies and pharmaceutical manufacturers.

1. A method of transferring medical information, said method comprising the steps of:
a. inputting information from a doctor's prescription into a computer database, and
b. transferring said information to a patient's electronic device to prompt the patient with a reminder.

2. The method of claim 1 wherein said information comprises the name of the medicine, the dosage amount and the medication interval.

3. The method of claim 1 wherein said computer database is located at a central location and said method includes the step of selectively transmitting said information to and from said database, from and to a doctor's office, a pharmacy, or other medical treatment facility.

4. The method of claim 3 wherein said information comprises patient identification data, name of prescribed medicines, medical history, current medical condition, and emergency information, said method including the step of protecting selected portions of said information against improper disclosure.

5. The method of claim 2 wherein said step of inputting information further includes inputting data relating to appointments, treatment regimens, active prescription medicines, allergies, medical history, current medical condition, current physicians, and emergency contact information with respect to said patient.

6. The method of claim 5 including the step of obtaining the patient's permission to store and transfer said information and data.

7. The method of claim 6 wherein said step of inputting information and said step of transferring said information are performed electronically either by wire or wireless transmission.

8. The method of claim 7 wherein selected doctors, pharmacies, pharmaceutical manufacturers and emergency medical personnel can perform the step of accessing said database for down loading selected information.

9. A system of storing and transferring medical information, said system comprising a computer having a computer memory for receiving and storing said information, means for transferring said information to and from said memory, and means for sending selective portions of said information to a patient's electronic device to prompt the patient with a reminder.

10. The system of claim 9 wherein said means for sending said information to said patient links said memory with a patient's electronic device, and said information comprises the name of a medicine, the dosage amount and the medication interval.

11. The system of claim 9 wherein said means for transferring said information to and from said memory comprises electronics means for sending said information by hard wire or wireless transmission.

12. The system of claim 9 wherein said computer is located at a central location and receives and transfers said information by hard wire or wireless means selectively from and to the patient, the patient's doctor, a pharmacy and a medical treatment facility.

13. The system of claim 12 wherein information received, stored and transferred from said memory comprises patient identification data, name of prescribed medicines, patient's medical history, patient's current medical condition, and emergency information, and said computer contains means for protecting selected portions of said information against improper disclosure.

14. The system of claim 10 wherein said computer memory contains data relating to appointments, treatment regimens, active prescription medicines, allergies, medical history, and current medical condition, current physicians and emergency contact information with respect to said patient.

15. The system of claim 14 wherein said computer memory contains evidence of the patient's permission to store and transfer said information and data.

16. The system of claim 15 wherein said means for transferring said information to and from said memory comprises electronics means for sending said information by hard wire or wireless transmission.

17. The system of claim 16 wherein said computer memory contains a program for providing access to said information by only the patient and selected doctors, pharmacies, pharmaceutical manufacturers and emergency medical personnel.

18. The system of claim 17 wherein said computer is a part of a central system and information is accumulated with respect to a plurality of patients.

19. A method of accumulating medical data including the steps of:
a. creating a computer database;
b. transferring prescription medical information into said database from pharmacies and doctors' offices for accumulating a sizable amount of data;
c. transferring into said database demographic information relating to patients' medical condition, age, diagnosis and treatment protocols; and
d. allowing access to said database by selected doctors, pharmacists and pharmaceutical manufacturers.
